(19) United States
(12) Patent Application Publication
(10) Pub. No.: US 2009/0066525 A1
(43) Pub. Date: Mar. 12, 2009

(54) Smoke meter and locator

(76) Inventor: Thomas Walsh, Long Beach, NY (US)

Correspondence Address: WEISS & WEISS, Suite 251, 300 Old Country Road, Mineola, NY, 11501, US

(21) Appl. No.: 12/231,148

(22) Filed: Aug. 28, 2008

Related U.S. Application Data
(60) Provisional application No. 60/966,486, filed on Aug. 28, 2007.

(51) Int. Cl. G08B 17/10

(52) U.S. Cl. 340/629; 340/628; 340/630

(57) ABSTRACT

A device which provides a smoke meter and locator.

### RELATED APPLICATIONS

The following application claims priority to U.S. provisional patent application Ser. No. 60/966,486 filed Aug. 28, 2007.

### FIELD OF THE INVENTION

The present invention relates to a device which provides a smoke meter and locator.

### BACKGROUND OF THE INVENTION

U.S. Pat. No. 6,380,860 relates to a portable wireless cellular fire alarm system apparatus and method. A portable wireless cellular fire alarm system is completely contained in a single rugged readily transportable suitcase.

U.S. Pat. No. 7,126,487 relates to a circuit and method for prioritization of hazardous condition messages for interconnected hazardous condition detectors. This circuit and method prioritizes the various hazardous condition alarms to ensure that only the highest priority or greatest threat alarm is sounded when such a condition is detected.

U.S. Pat. No. 6,937,743 relates to a process and device for detecting fires based on image analysis, flame and/or smoke recognition. The analysis is based on several image processing algorithms.

U.S. Pat. No. 6,819,252 relates to a carbon monoxide and smoke detection apparatus. The smoke sensor and carbon monoxide sensor are integrated into a common detector housing. The smoke sensor is coupled to a smoke detector control integrated circuit which generates a binary output signal indicative of the presence of smoke. The signal is coupled to a programmed microprocessor along with the carbon monoxide sensor. The outputs from the two sensors are processed substantially independently.

U.S. Pat. No. 6,204,768 relates to a fire monitoring system and fire sensor. A multi-sensor type sensor has sensor processors for generating detection data of plural types based on detection signals from a plurality of sensor portions, and a mode switching portion for switching a mode which indicates type of data to be sent to a receiver in response to a mode switching instruction issued from the receiver, and sending selectively the data of the type which corresponds to a current switching mode in response to a data request instruction issued from the receiver. The receiver includes a mode switching indicating portion for switching the mode by transmitting the mode switching instruction which selects type of response data to the fire sensors, and a fire judging portion for judging the fire by receiving the response data from the fire sensors in response to transmission of the data request instruction.

U.S. Pat. No. 6,150,935 relates to a fire alarm system with discrimination between smoke and non-smoke phenomena. The alarm system incorporates a plurality of highly sensitive, early warning, smoke detectors incorporates functionality for distinguishing between detector signals in response to ambient smoke and detector signals in response to the presence of non-smoke, fibrous materials. If previously stored history indicates a fire related profile, such as a relatively gradual increase in smoke level over a period of time, the signal from that detector is regarded as being indicative of smoke and an alarm is indicated.

US Patent Pub. No. 2006/0261967, relates to a smoke detector that includes at least one image-forming reflective surface, at least one light source and at least one light sensor.

U.S. Pat. No. 6,873,256 relates to an intelligent building alarm. System and method for detecting, monitoring, and evaluating hazardous situations in a structure includes the use of an expert system and, a fuzzy logic system in the generation of solution sets. The units are high-level multifunctional detectors, RF and other wireless or hardwired communication modules and signal generating systems that may communicate with a base station, with other modules and/or may have onboard logical solution generation capacity.

U.S. Pat. No. 7,019,646 relates to a combination smoke alarm and wireless location device. The invention relates to a device and method for determining and automatically transmitting a geographic location of a wireless smoke alarm during a potential fire emergency. The wireless smoke alarm includes a smoke alarm interfaced with a wireless transceiver, which operates over an existing wireless telecommunications network.

U.S. Pat. No. 5,798,701 relates to a self-adjusting smoke detector with self-diagnostic capabilities. It includes a microprocessor based alarm control circuit that periodically checks the sensitivity of a smoke sensing element to a smoke level in a spatial region.

U.S. Pat. No. 6,958,689 relates to a multi-sensor fire detector with reduced false alarm performance. A method of detecting a combustion chemical in a region and setting an alarm based on concentration levels of the combustion chemical comprises the steps of: monitoring the region for a combustion chemical with a sensor which changes in value in proportion to the concentration of the chemical. The measurable parameter being ambient temperature.

### SUMMARY OF THE INVENTION

The present invention relates to a device which provides a smoke meter and smoke locator.

It is an object of the present invention for the device to sense smoke the same as present smoke detectors sense smoke.

It is an object of the present invention for the device to sense small traces of smoke.

It is an object of the present invention for the device to show a user where the stronger concentrations of smoke are located.

It is an object of the present invention to locate the source of the smoke when it is not visible to the eye.

It is an object of the present invention for the device to have a fixed probe.

It is an object of the present invention for the device to have a flexible probe.

It is an object of the present invention for the device to have an extendable probe.

It is an object of the present invention for the device to comprise a meter which shows the user when the concentration of smoke is increasing.

It is an object of the present invention for the device to have lights which increase in intensity when a user is getting closer to the source of the smoke.

It is an object of the present invention for the device to have audible sounds such as beeping when a user is getting closer to the source of the smoke.

It is an object of the present invention for the device to be rechargeable or use batteries.

It is an object of the present invention for the device to be activated when a smoke detector goes off to assist in finding the source of the smoke or burning object.

It is an object of the present invention for the device to be part of a multi-meter or multi-sensing unit.

It is an object of the present invention for the device to have a wide detecting range.

It is an object of the present invention for the device to determine what type of smoke is present.

It is an object of the present invention for the device to determine whether the smoke is from an electrical fire, wood burning, etc.

It is an object of the present invention for the device to have adjustable sensitivity.

It is an object of the present invention for the device to have a low battery alarming indication.

It is an object of the present invention for the device to have a shorter buzzer sound interval, the higher the concentration of smoke.

It is an object of the present invention of the device to use a different color light or a different sound to identify each type of smoke.

It is an object of the present invention for the device to have auto zero calibration.

It is an object of the present invention for the device to detect the differences in smoke by using the device that is calibrated to measure density levels.

It is an object of the present invention for the device to be calibrated to measure opacity levels.

### BRIEF DESCRIPTION OF THE DRAWINGS

FIG. 1 shows a smoke meter of the present invention.

FIG. 2 shows a smoke locator of the present invention.

### DETAILED DESCRIPTION OF THE INVENTION

The present invention relates to a device which provides a smoke meter and smoke locator.

The device can sense smoke the same as present smoke detectors sense smoke. The device senses small traces of smoke.

In an embodiment, the device shows a user where the stronger concentrations of smoke are located.

In an embodiment, the device locates the source of the smoke when it is not visible to the eye. In an embodiment, the device has a fixed probe. In an embodiment, the device has a flexible probe. In an embodiment, the device has an extendable probe.

In an embodiment, the device comprises a meter which shows the user when the concentration of smoke is increasing.

In an embodiment, the device has lights which increase in intensity when a user is getting closer to the source of the smoke. In an embodiment, the device has audible sounds such as beeping when a user is getting closer to the source of the smoke.

The device is rechargeable and/or uses batteries.

In an embodiment, the device is activated when a smoke detector goes off to assist in finding the source of the smoke or burning object.

In an embodiment, the device is part of a multi-meter or multi-sensing unit. In an embodiment, the device has a wide detecting range.

In an embodiment, the device determines what type of smoke is present.

In an embodiment, the device determines whether the smoke is from an electrical fire, wood burning, etc.

In an embodiment, the device has adjustable sensitivity. In an embodiment, the device has a low battery alarming indication. In an embodiment, the device has a shorter buzzer sound interval, the higher the concentration of smoke.

In an embodiment, the device uses a different color light or a different sound to identify each type of smoke.

In an embodiment, the device has auto zero calibration.

In an embodiment, the device detects the smoke by measuring density levels. In an embodiment, the device is calibrated to measure opacity levels.

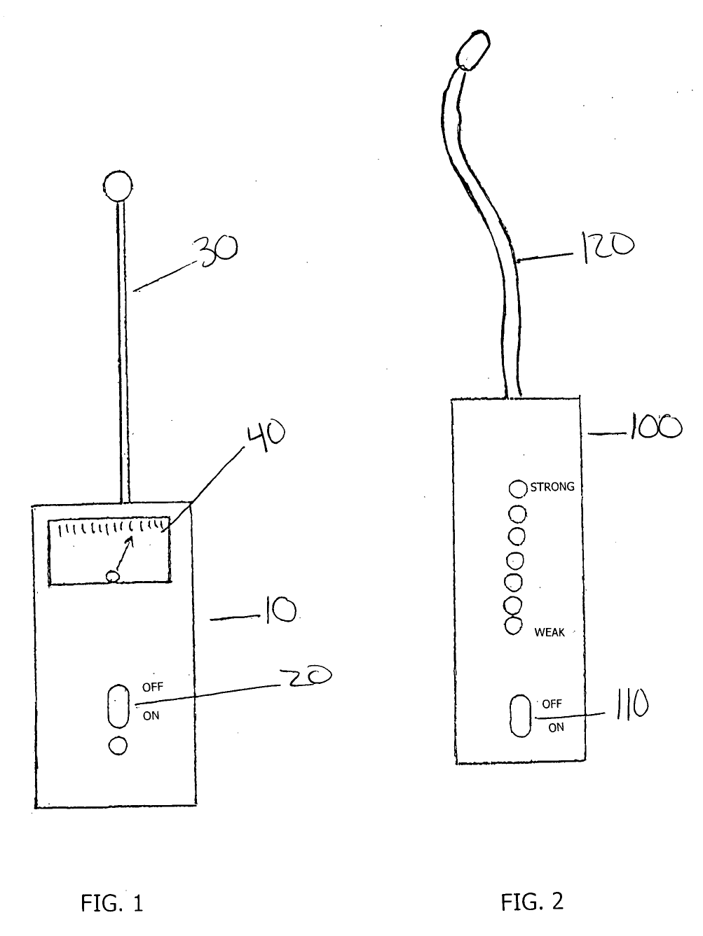

FIG. 1 shows a smoke meter 10 have an off/on switch 20, and a probe 30. The probe 30 can either be fixed, flexible or extendable. The probe 30 detects the presence of smoke. Once the smoke is detected, a meter 40 determines the concentration of the smoke and gives a reading based on that concentration.

FIG. 2 shows a smoke locator 100 having an off/on switch 110 and a probe 120. The probe 120 can either be fixed, flexible or retractable. The probe 120 detects the presence of smoke. The probe 120 can determine whether the smoke is of a strong concentration or a weak concentration. Based on the concentration, the device 100 will either show a user either visually or audible whether the concentration of smoke is weak or strong and help a user determine where the smoke is originating from.

### EXAMPLE 1

The device is turned on. The sensor of the device is placed into the smoke environment, and the Lights or sound frequency shows the concentration of the smoke. As the concentration of the smoke increases, the frequency of the lights and/or the sound will increase.

If the detector indicates a small concentration of smoke, the user can set this as the zero point, then the detector accepts the present level as zero.

Plastics tend to produce larger particle smoke than cellulose material produces. Smoldering fires tend to produce larger particles than flaming fires, “Aged” smoke, i.e. smoke that has moved some distance away from the fire tends to have larger particles than the smoke from the same fire that is still near the fire.

An ionization smoke detector has a small amount of radioactive material that ionizes the air in the sensing chamber, rendering the air conductive and permitting a current flow the air between the two charged electrodes. This gives the sensing chamber an effective electrical conductance. When smoke particles enter the ionization area, they decrease the conductance of the air by attaching themselves to the ions, causing a reduction in ion mobility. When the conductance is below a pre-determined level, the detector responds.

A photoelectric detector operates on a light scattering principle. They contain a light source and a photosensitive device arranged so the light rays normally do not fall onto the device. When smoke particles enter the light path, light strikes the particles and is scattered onto the photosensitive device, causing the detector to respond.

1. A device which detects where smoke is originating from comprising:
a probe;
a meter;
a battery or charger;

2. The device of claim 1 wherein said device senses small traces of smoke.

3. The device of claim 1 wherein said device shows a user where stronger concentrations of smoke are located.

4. The device of claim 1 wherein said device locates source of smoke when it is not visible to a human eye.

5. The device of claim 1 wherein said device has a fixed probe.

6. The device of claim 1 wherein said device has a flexible probe.

7. The device of claim 1 wherein said device has an extendable probe.

8. The device of claim 1 wherein said device has lights which increase in intensity when a user is getting closer to source of smoke.

9. The device of claim 1 wherein said device makes audible sounds such as beeping when a user is getting closer to source of smoke.

10. The device of claim 1 wherein said device is rechargeable or uses batteries.

11. The device of claim 1 wherein said device is activated when a smoke detector goes off to assist a user in finding source of smoke or burning object.

12. The device of claim 1 wherein said device to senses smoke the same as smoke detectors sense smoke.

13. The device of claim 1 wherein said device determines type of smoke present.

14. The device of claim 1 wherein said device determines whether the smoke is from an electrical fire, wood burning fire, etc.

15. The device of claim 1 wherein said device has adjustable sensitivity.

16. The device of claim 1 wherein said device comprises a low battery alarm indication.

17. The device of claim 1 wherein said device uses a different color light or a different sound to identify each type of smoke.

18. The device of claim 1 wherein said device comprises auto zero calibration.

19. The device of claim 1 wherein said device detects smoke based on measuring density levels.

20. The device of claim 1 wherein said device detects smoke based on measuring opacity levels.

21. The device of claim 1 wherein said device detects smoke based on ionization detection.

22. The device of claim 1 wherein said device detects smoke based on photoelectric detection.
